(19) United States
(12) Patent Application Publication
(10) Pub. No.: US 2008/0071663 A1
(43) Pub. Date: Mar. 20, 2008

(54) User interface tab strip

(76) Inventor: Andrew Busby, Aurora, IL (US)

Correspondence Address: MCGUIREWOODS, LLP, 1750 TYSONS BLVD, SUITE 1800, MCLEAN, VA, 22102, US

(21) Appl. No.: 11/523,748

(22) Filed: Sep. 19, 2006

(51) Int. Cl. G06Q 40/00

(52) U.S. Cl. 705/37

(57) ABSTRACT

A method for reducing the amount of time for a user switch markets for a particular contract is provided. Market tab strips in accordance with the present invention allow a user to switch quickly between markets for a particular contract without having to reconfigure the user preferences. Typically, a user will have to reconfigure the market window layout if switching between markets. It is advantageous to provide a market tab strip that allows a user switch between different markets for a particular contract without have to spend time reconfiguring the market window.

### FIELD OF THE INVENTION

The present invention relates to the field of trading commodities. More particularly, the present invention relates to the improvement of a software application in order to trade commodities over an exchange. Even more particularly, the present invention relates to improving a software application to change the displays of the market data subscription in order to improve trading over an exchange. However, it is to be appreciated that the present invention is amenable to other like applications.

### BACKGROUND OF THE INVENTION

In general, commodities have been traded in the same way for hundreds of years. The Chicago Board of Trade (“CBOT”) began trading commodities in the 1800's. Since the inception of the CBOT, many different exchanges all over the world exist and each trade commodities. Many markets exist for each contract. One or more markets for each contract expire according to an exchange determined schedule. Typically, markets expire on the same day each month or the same day each quarter. This is called market expiration or “Roll Over.” A contract's current month is called the contract's front month. This may or may not be the month with a contract's first available outright market (first to expire).

More recently, electronic commodities trading has been added to the exchanges. This has permitted vast accessibility to these exchanges without requiring that a user be present within the exchange and without the necessity of “paper trades.” Not only has the use of electronic trading greatly increased the ability for users to trade commodities, but has also increased the volatility of the exchanges, since there are more users that have easier and faster access to the exchanges.

Electronic trading of commodities is achieved through a combination of exchange hosts, Internet service providers (“ISPs”) and application service providers (“ASPs”). The exchange hosts are primarily responsible for order routing, price dissemination and connectivity, which includes not only bidirectional communication but also preserving redundancy.

The ASPs that are utilized in electronic commodities trading are responsible for, among other things, maintaining connectivity, hosts and clients. Connectivity is maintained with respect to exchange hosts through bidirectional communication with redundancy. The hosts are responsible for risk management throughout the trading day as well as the back office integration/imports. Hosts are also responsible for connectivity of the client session management, price dissemination and order routing.

The client is what the user interacts with directly, typically a piece of software. The client is responsible for connectivity through the Internet and through direct connection. The client typically includes a client session management feature which will monitor the connectivity of the client. Moreover, the client will typically include a configurable display that includes prices not only of the last trade, but also of the depth of market. The client also allows the user to manipulate orders, keep track of an order book and monitor account status, including balances, profit and loss and positions.

Each of the exchanges has requirements in order for the hosts and the clients to participate in the market. While the exchange interface is the same for all participants, the different ASPs and proprietary systems interfaces can and do differ. Trading tools such as those described in embodiments of the present invention optimize these differences in proprietary systems, allowing some systems to be more efficient than others. In developing proprietary systems, user error is minimized, total user actions are minimized and repeated actions are simplified or eliminated.

Exchanges utilizing embodiments of the present invention include a number of different contracts, where each contract is a commodity traded at an exchange that consists of one or more tradable markets of different expiry dates. Although not all contracts have exchange provided strategies, many do. An exchange provided contract with strategy is a commodity traded at an exchange that consists of one or more tradable markets of different expiry dates and strategies consisting of one or more combinations of those tradable markets. Strategies that are contemplated for use with contracts include Calendar Spread, Reduced Tick Calendar Spread, Butterfly, Condor, Double Butterfly, Horizontal Spread, Bundle, Pack, Pack Spread, Pack Butterfly, Bundle Spread, and others as would be appreciated by those of ordinary skill in the art.

The following invention has been designed for the electronic commodities trading industry. The invention is intended to be incorporated into electronic trading tools and software applications for trading commodities. The key to executing or manipulating trades in an electronic market is speed. Therefore, embodiments in accordance with the present invention reduce the time it takes for a user to perform specific activities. The present invention thus improves the efficiency of user activities and adds value to an electronic trading system.

### SUMMARY OF THE INVENTION

In accordance with one embodiment of the present invention, an improved method for monitoring commodities over an exchange having contracts with multiple tradable markets is provided. The method utilizes a software application and comprising the steps of providing a user interface tab strip where the user interface tab strip includes a plurality of individually selectable tabs. Furthermore, each of the individually selectable tabs corresponds to a tradable market having a unique expiry date for each contract. The user interface tab strip allows a user to switch between tradable markets by selecting a desired individually selectable tab corresponding to a desired tradable market.

In accordance with another embodiment in accordance with the present invention, an improved method for monitoring commodities over an exchange having contracts with multiple tradable markets is provided. The method utilizes a software application and includes the step of providing a user interface tab strip including a plurality of individually selectable tabs. Furthermore, each of the individually selectable tabs corresponds to a tradable market having a unique expiry date for each contract. Also included in the method is the step of applying a filter to the user interface tab strip so as to display a plurality of individually selectable tabs, where all of the individual tabs together represent a subset of tradable markets for each contract, thereby allowing a user to select a tradable market from the subset of tradable markets by selecting an individually selectable tab corresponding to a desired tradable market.

In accordance with another embodiment of the present invention, an improved method for monitoring commodities over an exchange having contracts with multiple tradable markets is provided. The method utilizes a software application and includes the step of providing a user interface tab strip that includes a plurality of individually selectable tabs. Each of the individually selectable tabs includes a drop-down list of tradable markets having a unique expiry date and strategy type for each contract. The method further includes allowing a user to select a tradable market by selecting an individual drop-down list item from the individually selectable tab corresponding to a tradable market.

In accordance with another embodiment of the present invention, a user interface tab strip includes a first individually selectable tab displaying a first tradable market in a pre-determined list of tradable markets for said contract.

In accordance with still another embodiment of the present invention, a user interface tab strip includes a second individually selectable tab displaying a second tradable market in a pre-determined list of tradable markets.

In accordance with a further embodiment of the present invention, upon user selection of each of the individually selectable tabs, corresponding market data for said tradable market is displayed.

In accordance with a yet further embodiment of the present invention, said corresponding market data is at least one of a bid price, an offer price, a trade price or combination of a bid price, an offer price, and a trade price.

In accordance with a still further embodiment of the present invention, each of the individually selectable tabs within the plurality of individually selectable tabs becomes graphically accented upon selection.

In accordance with yet another embodiment of the present invention, each of the individually selectable tabs may be selected by a user clicking on a desired tab.

In accordance with another embodiment of the present invention, a user of said user interface tab strip may traverse from a first individually selectable tab to a second individually selectable tab by selecting a pre-determined key button on a keyboard; wherein said keyboard can be used in conjunction with said software application.

In accordance with a still further embodiment of the present invention, said pre-determined button is a Tab button.

In accordance with a yet further embodiment of the present invention, each individually selectable tab within the user interface tab strip is horizontally adjacent to the previous individually selectable tab.

In accordance with a further embodiment of the present invention, a user interface tab strip includes a horizontal scroll bar to allow a user of said user interface tab strip to access any of the individually selectable tabs not visible to the user, wherein the user may select a portion of said horizontal scroll bar to effectuate movement of the visible screen.

In accordance with yet another embodiment of the present invention, said filter can be applied to the superset of tradable markets for said contract so as to display the outright tradable markets for said contract.

In accordance with a further embodiment of the present invention, said filter can be applied to the superset of tradable markets for said contract so as to display tradable markets of a selectable strategy type.

In accordance with a yet further embodiment of the present invention, said selectable strategy type displays a plurality of individually selectable tabs that correspond to calendar spread tradable markets for said contract.

In accordance with still another embodiment of the present invention, said filter can be applied to the tradable markets for said contract so as to display exchange defined tradable markets for said contract.

In accordance with a still further embodiment of the present invention, said filter can be applied to the tradable markets for said contract so as to display the first two months of tradable markets for said contract.

In accordance with another embodiment of the present invention, said drop-down list is displayed as a button when said drop-down list contains one tradable market.

In accordance with still another embodiment of the present invention, said user interface tab strip includes a first individually selectable tab displaying a first ordered subset of tradable markets for said contract.

In accordance with a yet further embodiment of the present invention, said user interface tab strip includes a second individually selectable tab displaying a second ordered subset of tradable markets for said contract, wherein the tradable markets of the second ordered subset are disjoint of the tradable markets of the first ordered subset.

In accordance with a further embodiment of the present invention, each individually selectable tab within the plurality of individually selectable tabs displays a subset of corresponding tradable markets upon selection of each of the individually selectable tabs; wherein the corresponding tradable markets of each of the individually selectable tabs subset is disjoint of the corresponding tradable markets of each other individually selectable tab subset within the plurality of individually selectable tabs.

In accordance with a still further embodiment of the present invention, each subset represented by each of the individually selectable tab drop-down list is displayed in a predetermined order.

In accordance with an embodiment of the present invention, upon user selection of each individually selectable drop-down list item, corresponding market data for said tradable market is displayed.

In accordance with an embodiment of the present invention, each of the individually selectable tabs may be selected by a user clicking on an individual drop-down list item from the individually selectable tab.

In accordance with another embodiment of the present invention, said drop-down list of each of the individually selectable tabs can be expanded by actuating predetermined key strokes.

In accordance with yet another embodiment of the present invention, said tab drop down list item within said drop-down list may be selected by a user clicking to expand the list, followed by clicking on the desired item.

In accordance with still another embodiment of the present invention, each tradable market of the drop-down list may be selected by a user actuating a predetermined key stroke.

In accordance with a further embodiment of the present invention, each individually selectable tab within the plurality of individually selectable tabs represents a single tradable market.

In accordance with a yet further embodiment of the present invention, selecting a second individually selectable tab within the plurality of individually selectable tabs displays market data corresponding to said second individually selectable tab.

In accordance with a still further embodiment of the present invention, selecting a tradable market within said drop-down list displays market data corresponding to the selected tradable market, switches to the item's corresponding tradable market and updates said tab's default market.

In accordance with another embodiment of the present invention, selecting a tradable market within said drop-down list further switches to the corresponding tradable market.

In accordance with a still further embodiment of the present invention, selecting a tradable market within said drop-down list further updates said tab's default market.

In accordance with yet another embodiment of the present invention, the first tradable market displayed in the drop-down list is the default tradable market.

In accordance with yet another embodiment of the present invention, the most recently selected tradable market in the drop-down list remains the default market.

### BRIEF DESCRIPTION OF THE DRAWINGS

FIG. 1 illustrates an exemplary embodiment of a client component used in conjunction with software applications that are contemplated for use with the present invention.

FIG. 2 illustrates an exemplary embodiment of a server component used in conjunction with software applications that are contemplated for use with the present invention.

FIG. 3 illustrates an exemplary embodiment of the present invention.

FIG. 4 illustrates another exemplary embodiment of the present invention.

FIG. 5 illustrates yet another exemplary embodiment of the present invention.

### DETAILED DESCRIPTION OF AN EMBODIMENT OF THE INVENTION

In accordance with one embodiment of the present invention, an improved software application is provided for reducing the time it takes for a user to change subscription between contract markets. In one embodiment, a user interface tab strip is provided of available markets that allow a user to change the displayed market data subscription while leaving the general layout of the display unchanged.

Software applications that can be used with the user interface tab strips in accordance to the present invention typically include four main parts: a backend, an application program interface (API), a client and a server.

The backend of software applications for trading commodities over an exchange typically includes a historical order book, which keeps a record of all of the orders placed by a user. In addition, the backend will typically store reports related to the users order activity and order routing performance. The backend will also preferably allow for back office statement publishing.

In addition, the backend of software applications for trading commodities over an exchange will preferably also include an administration component. The administration component can include a number of features or tasks for the software application including, but not limited to, general system maintenance, organization of applications, database of firms, database of trading accounts and a database of users.

General system maintenance within the administration component can include storing various configurations of the software application, including graphical user interface defaults and options. Moreover, the general system maintenance may include monitoring between the network backend and the client portion of the software application to insure, for example, that a network connection is continually maintained and to inform if there is a broken network connection. The general system maintenance may also include maintenance, for example, involving anti-virus updates, software application updates, debugging updates and the like.

Applications for use with software applications used in conjunction with the present invention include those applications that provide organization of licenses, which for example, authorize a user to perform trades of commodities. In addition, the licenses and other applications may be organized to enable or disable certain licenses depending on the level of authorization of the user of the software application. For example, a user may only be authorized to trade a certain monetary value, and therefore, the software license that allows that user to trade may be disabled above the predefined value. As a further example, the application may be only licensed to users that have a certain series of license, e.g., a Series 7 license.

In addition, the backend component of software applications for use with the present invention may also include a database that allows for organization of firms. This allows the user to create and edit the firms with the database, as well as enable and disable firms' access to the software applications. In addition, the database of firms can include information including the assignment of applications, the configuration of branding, the assignment of firm roles, and the selection of exchanges and setting the executing logins. The assignment of firm roles includes, for example, any of trading, pit trades, data files, self registration and refer self registration.

The backend component of software applications for use with the present invention preferably also includes a database of trading accounts, which also allows for the user to create, edit, delete and adjust account specific risk specific parameters. In creating trading accounts, the database will preferably include information such as the account number, risk parameters and any details that are required by the exchange.

Further, the backend component of software applications for use with the present invention may include a database of users, which allows the user to create, edit or delete users of the software application. In creating a user, the database will preferably include information such as the assignment of a user name and password, user contact details, the assignment of accounts and the assignment of user roles. The user roles that have been assigned may include information relating to the administrator, the risk manager, trades, pit trades as well as data files.

Software applications for use with the present invention also typically include an application program interface (API). The API consists of a set of objects or methods included with the client. The API provides developers a standard programming interface for the server. Applications that interface with the server typically implement the API.

The API provides all of the objects necessary to trade the software applications supported electronic futures exchanges. Included are methods for market data subscription as well as risk managed order routing.

To develop an API for use with the present invention, a development tool is typically utilized, such as Microsoft Visual Studio Net. At a minimum, the API establishes a session with the server by supplying certain parameters, including, for example, the application license, the server URL, the server type (for example, simulation or live) and the firm, username and password. It is preferred that the above parameters be hard coded with the exception of the firm, user name and password, which is preferably a user input at runtime.

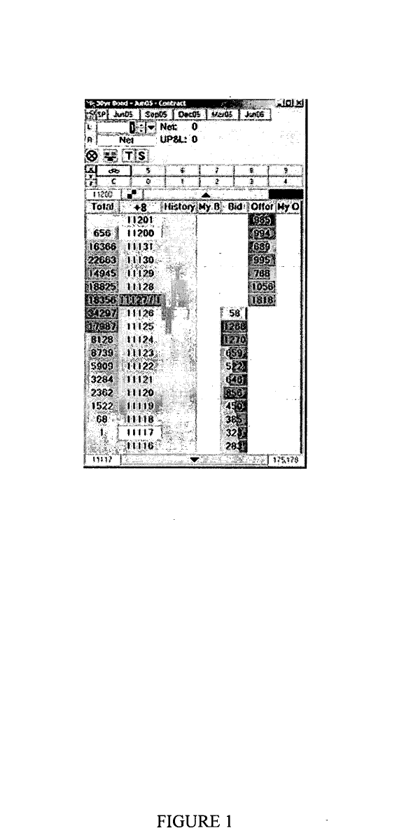

Software applications for use with the present invention also preferably include a client component. The client is an Internet-based system that can be accessed from anywhere in the world and offers access to multiple futures exchanges and provides a custom trading front-end that is intended for professional and retail users. An example of a client component contemplated for use with the present invention is shown at FIG. 1.

The client component preferably provides a contract window as the main order execution window. There are typically three main columns: price, bid and offer. The price column is typically a vertical list of market prices listed in descending order from top to bottom. Every valid market price is preferably listed with no gaps in the prices. The bid and offer columns preferably run parallel to the price column and display the current market depth (bids and offers at each price). For example, if there were 3 users attempting to buy 5 March Mini Dow contracts each at 11100, the bid column would display a 15 at the intersection of the Bid column and the 11100 row. If those 3 people then attempted to sell 5 March Mini Dow contracts, each at 11108, the offer column would display a 15 at the intersection of the offer column and the 11108 row. Both examples assuming that there were no other users in the market.

The client software, once installed onto the user's computer, includes a main window which preferably includes a number of user controlled settings, such as the currently trading account, creating new items, change global properties and save global properties. In addition, the profit and loss and cash for the currently trading account are preferably displayed. The lower portion of the main window preferably includes information such as the software application status, any status messages and the user name.

Software applications for use the present invention also preferably include a server component. The server component is typically an n-tier distributed application that is designed to be robust, secure and scalable. The server preferably consists of a number of tiers, including: an Exchangehandler, an AccountHandler and a UserHandler. Each of these can be run on separate servers, or they can all be run on the same server, or any combination thereof. Multiple instances of each tier can be run at the same time to achieve load balancing and failover redundancy. Each tier communicates with the others using messages sent over TCP/IP sockets, multicast or Microsoft Message Queue services.

The ExchangeHandler typically deals with the communication with the actual futures exchanges, such as CBOT, CME, etc. This tier effectively provides a common interface for the rest of the applications to communicate with different exchange technologies (such as LIFFE Connect, FIX, etc.).

For each exchange that the system communicates with, a Driver is typically created that deals with the translation between that specific exchange API and the varying data formats of the software application. The Driver updates caches of information within the ExchangeHandler with updates to that market data, quotes or orders. Then ExchangeHandler typically then deals with forwarding that information onto the AccountHandlers and UserHandlers based on what information they have subscribed to get.

The AccountHandler is typically central for the accounts and orders for the current day in the system. The orders submitted by a user are typically sent through the AccountHandler and checked for various risk management parameters, such as maximum size, margin requirement, etc., before being sent to an ExchangeHandler for sending to the actual exchange. When an order is confirmed by an exchange, or is filled or cancelled, the message is forwarded from the exchange, via the ExchangeHandler, to the AccountHandler where the order record is updated to reflect the new state of the order. The updated order state is then sent to the end-user via the UserHandler.

Servers for use with the present invention also preferably include a UserHandler. The UserHandler typically deals with the connections established by the end-users with the frontend, typically via the API. Access to the system by an end-user is preferably achieved through this component. The UserHandler preferably maintains a secure connection with the user via SSL encryption, and for authenticating the user and the permissions that the user has been assigned. It is contemplated that other means of maintaining a secure connection and authenticating users and permission may be implemented as would be appreciated by those of ordinary skill in the art.

Quote data from the exchanges and the order and trade confirms from the AccountHandler are preferably forwarded through the UserHandler to the end-users depending on the data that each user has subscribed to. Orders submitted and requests for data from the end-user are typically processed through the UserHandler first, and then forwarded to the appropriate account handler or exchange handler.

It is advantageous to have many instances of the UserHandler tier, preferably on multiple machines, which would allow for hundreds or thousands of users to be connected to the system at the same time. If one instance failed, the users connected to it would automatically reconnect to another instance causing minimal outage time for the end-user.

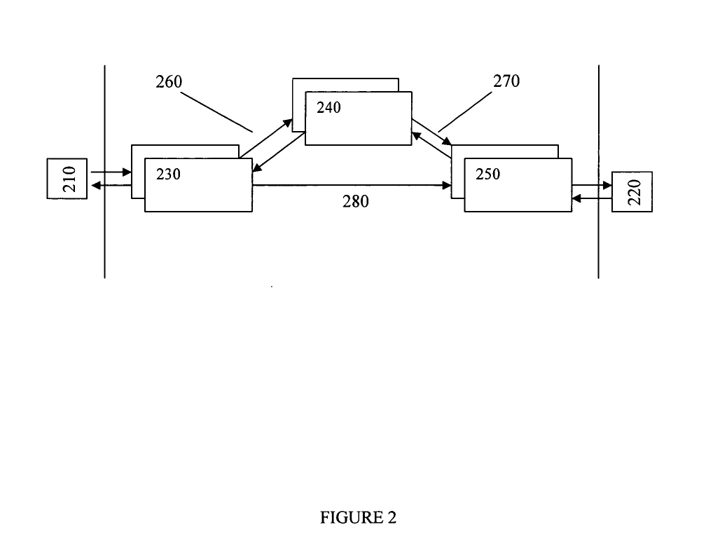

Server components contemplated for use with the present invention typically are in the format described in the flowchart of FIG. 2.

It is contemplated that user interface tab strips in accordance with the present invention can be used with software applications including any number of the components described herein. It is further contemplated that although user interface tab strips are typically used in trading software applications in order to buy and sell commodities over an exchange, other like applications could be utilized as would be appreciated by those of ordinary skill in the art. For example, it may be desirable for a user of user interface tab strips in accordance with the present invention to simply monitor and track commodity prices, without actually buying and selling the commodity.

A user interface tab strip in accordance with the present invention is preferably included in a software application to help users trade commodities over exchanges. It is contemplated, however, that user interface tab strips in accordance with the present invention may be added to existing software applications in order to achieve the features described herein.

User interface tab strips in accordance with the present invention allow, among other advantages, for the user to easily switch between multiple contract markets of the same contract. For example, a user of a software application opens a contract picker and selects an exchange. Once the exchange has been selected, the user can select a desired contract. Upon selection of a contract, a contract market window is displayed with a user interface tab strip in accordance with one embodiment of the present invention displayed at the top. The highlighted tab of the user interface tab strip is preferably selected by default, which may correspond to the first tab on the user interface tab strip and can be changed based on user preferences. The user can then customize the contract window layout once for all of the markets that are listed within the user interface tab strip. Thus, if a user desired to switch from trading March to trading June, the user would simply click the “June” tab at the top of the window within the user interface tab strip, and all of the user preferences would remain the same.

Software applications that do not incorporate user interface tab strips in accordance with the present invention do not have the same advantages. Indeed, systems that do not include the use of a user interface tab strip have limited, if any, ability to switch to other markets quickly. For other systems, a user opens a market picker and selects an exchange. The user then has the option of choosing a particular contract and then a particular market for that contract. The user can then customize the market layout for the market window that is being displayed. However, if the window is closed to open another market, the user must reconfigure the layout, including repositioning and resizing the window.

One advantage of user interface tab strips in accordance with embodiments of the present invention is that display configurations only have to be set once per contract rather than once for each market. Historically, market expiration, or “Roll Over,” forced users to repeat the same set of display configurations when move to a contract's new front month market. These configurations may include screen position, size, colors, fonts and other such configurations as would be appreciated by those of ordinary skill.

Indeed, the use of a user interface tab strip in accordance with the present invention also reduces support overhead. A large amount of users do not remember every step that is taken in configuring the market display for their specific needs. This is especially so when there is only a need to change the configuration of the market display every one to three months or for a new contract. When a user forgets how to configure the market display for their specific needs, that user will typically call technical support for assistance. By using the user interface tab strip in accordance with embodiments of the present invention, the number of calls to technical support is reduced, thereby resulting in cost savings for the business.

Another advantage of user interface tab strips in accordance with embodiments of the present invention is that the bandwidth usage of the application is kept to a minimum. Using a single window with a user interface tab strip in accordance with the present invention, rather than separate windows for each market allows the application to maintain a single price feed subscription per contract. Market subscription is handled dynamically by the software application. Only the highlighted market of the software application has an active subscription. All of the unhighlighted markets of the software application are unsubscribed. As a result, the software application is more network “friendly”, meaning that it is less demanding on the operating system and hence less likely to cause problems or interference with other software applications. Moreover, the overall bandwidth usage is kept down, which results in savings on bandwidth providers and hardware (such as servers, firewalls and switches).

A user interface tab strip in accordance with an embodiment of the present invention is typically a horizontal tab strip that is docked at the top of a software application for trading over exchanges. One example is a Client Contract and Market History screen. It is contemplated, however, that user interface tab strips in accordance with the present invention can be used interchangeably with different software applications depending on a user's preferences. Furthermore, it is contemplated that user interface tab strips in accordance with the present invention may be docked anywhere on the software application, for example, wherever the user desires. Moreover, it is contemplated that user interface tab strips in accordance with the present invention can be adapted to be added to or work simultaneously with existing trading software applications. One way that this could be achieved is through the design and use of plug-ins for user interface tab strips.

User interface tab strips in accordance with the present invention can list all available markets or a filtered subset of markets for a specified contract. For example, the user interface tab strips can list E-Mini S&P 500 Jun06, E-Mini S&P 500 Sep06 outrights and the E-Mini S&P 500 Jun06-Sep06 spread. Alternatively, a filtered subset of these markets could be just the E-Mini S&P 500 Jun06, E-Mini S&P 500 Sep06 outrights, for example. In one embodiment in accordance with the present invention, filters can be applied by the user via the use of a button along the user interface tab strips. The button may, for example, be designated to indicate its use, such as the designation of “SP” to denote the “spread” dropdown menu in order to reduce the number of markets that are being displayed.

User interface tab strips in accordance with the present invention preferably utilize a Contract object as an input. Each Contract object preferably has a Markets property that exposes a MarketList object upon selection. The MarketList object preferably corresponds to the Contract's collection of available markets in the correct display order. The MarketList object may contain outright markets and strategies. User interface tab strips in accordance with the present invention preferably iterates through the MarketList object and creates a tab for each unfiltered market.

As each tab on the user interface tab strip is created, they are preferably displayed horizontally from left to right. It is also contemplated that user interface tab strips in accordance with the present invention may be adapted to be displayed vertically, depending on the user's preference. Each new tab that is created is placed or docked on the right side (or below in the instance of vertical user interface tab strip) of the previously created tab. Preferably, adding a new tab to the right of a previously created tab will cause the user interface tab strip to extend in a linear horizontal fashion. The same is adaptable in the vertical configuration. If the user interface tab strips are created such that more tabs are created than can be displayed on the user's display, it is contemplated that scroll buttons will appear on the right end of the horizontal user interface tab strip. Using the scroll buttons the user is able to shift the tabs left and right bringing hidden tabs into view. Alternatively, once enough tabs have been created that certain tabs are hidden from the user's display, an elevator scroll may appear below the user interface tab strip in order to allow the user to “click and drag” an elevator bar to sections of the user interface tab strip that are hidden. It is contemplated that other means of accessing numerous tabs may be utilized as would be appreciated by those of ordinary skill.

Preferably, the tab within the user interface tab strip representing the current market is highlighted, thus setting it apart from the remaining tabs. Upon selecting one of the non-highlighted tabs on the user interface tab strip, by, for example, clicking on the tab using the user's mouse causes the user interface tab strip control to change the highlighted tab to the current tab and raise a MarketChanged event to the trading tool. The MarketChanged event notifies the trading tool that the end user desires to subscribe to a different market. It is contemplated that in some embodiments in accordance with the present invention, the trading tool can cancel the current market subscription and subscribe to the new market. It is also contemplated that the trading tool does not control market subscription and that market subscription may occur in any number of ways as would be contemplated by those of ordinary skill in the art, including manually by a user.

In accordance with embodiments of the present invention, the user interface tab strip may be set in different modes. One example of a mode for the user interface tab strip is group mode. In group mode, markets are displayed in drop down groups. Each group has a single tab. Any group with only a single item preferably does not display a dropdown arrow, as it is unnecessary. The group mode will allow the user to customize the grouping of the tabs, for example, the user may group the markets by month/front month and then by strategy type. There are a number of groupings and combinations of groupings that the user can use. For example, different types of groupings include grouping all outrights together, and strategies by type irrespective of month, grouping markets that the user has recently accessed together, or grouping the most active markets together. Strategy types that can be used in conjunction with user interface tab strips in accordance with the present invention include Calendar Spread, Reduced Tick Calendar Spread, Butterfly, Condor, Double Butterfly, Horizontal Spread, Bundle, Pack, Pack Spread, Pack Butterfly, Bundle Spread, etc. It is contemplated that many types of organization can be used in conjunction with user interface tab strips in accordance with embodiments of the present invention. It is also to be appreciated by those of ordinary skill that many other strategy types can be implemented with user interface tab strips of the present invention.

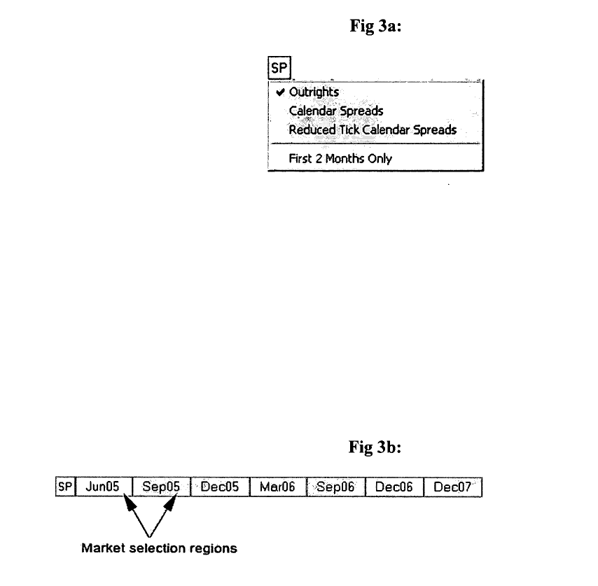

FIG. 3 is a depiction of a user interface tab strip in accordance with one embodiment of the present invention. In FIG. 3a, the user selects, typically by clicking with a mouse, a button that is pre-determined to filter the spreads. In FIG. 3a, the button is entitled “SP.” Upon selecting the button, a drop-down menu appears, in this case displaying various options, such as “Outrights,” “Calendar Spreads,” “Reduced Tick Calendar Spreads” and “First 2 Months Only.” In FIG. 3a, the user has elected to select the “Outrights” option from the drop-down menu, which is illustrated by the check mark next to the option. The check mark indicates that the option has been selected by the user and then the filter for “Outrights” is set. Once the selection for the “Outrights” filter has been made by the user, the current contract's outright markets are displayed, as shown in FIG. 3b.

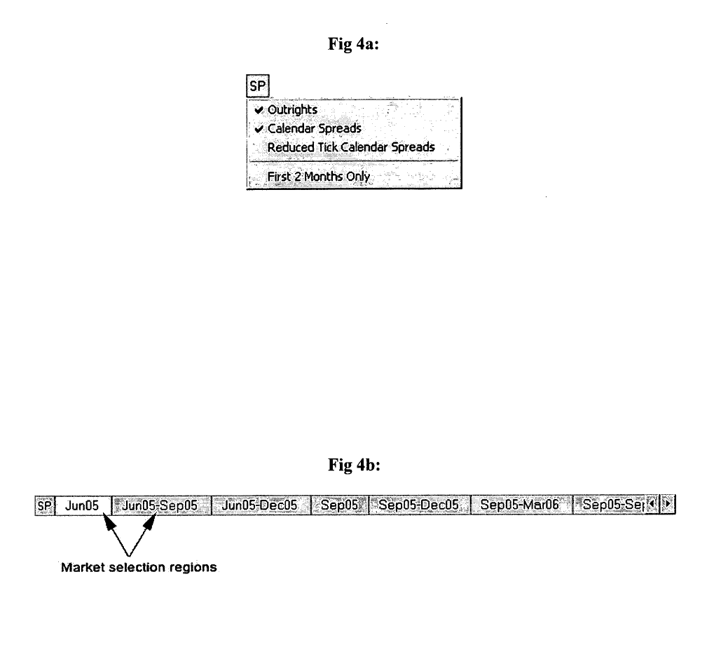

FIG. 4 also displays an embodiment in accordance with the present invention. In this embodiment, the “Outrights” filter is set as in FIG. 3. However, in addition to the “Outrights” filter, FIG. 4a also shows that the “Calendar Spreads” filter is also selected. It is contemplated that two filters can be used at the same time. Alternatively, it is also contemplated that some users may prefer to have a default whereby once a second filter is selected, the first filter is unselected, thereby only allowing one filter at a time. In the embodiment disclosed in FIG. 4, however, multiple filters may be set. As shown in FIG. 4b, the filters have been set to display the “Outrights” and the “Calendar Spreads.” For example, June 2005 is the current market in this example, and the calendar spread is shown by the “Jun05-Sep05” tab.

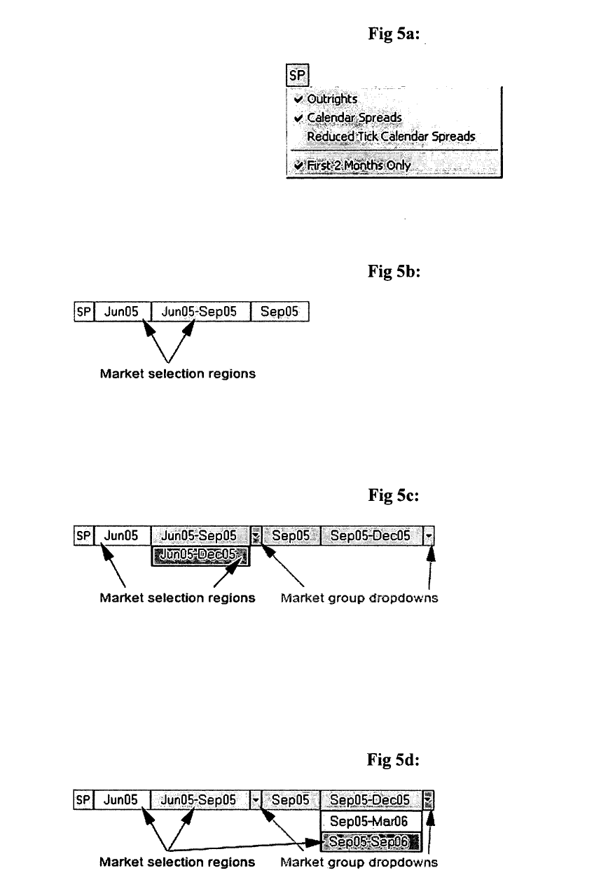

FIG. 5 displays yet another embodiment in accordance with the present invention. In accordance with the embodiment of FIG. 5, more than two filters are set using the “SP” button. Not only are the “Outrights” and “Calendar Spreads” filters applied, but, as shown in FIG. 5a, the “First 2 Months Only” filter is also applied. By selecting this filter, only the first two months of the outright and calendar markets are displayed, as shown in FIG. 5b.

As shown in FIG. 5c, the user interface tab strip in accordance with the present invention includes a market selection region and market group dropdowns. The application of the third filter (“First 2 Months Only”) filters months other than the next two, in this example, June and September. As shown in FIG. 5c, the user interface tab strip of this embodiment in accordance with the present invention displays the first two months of outright and calendar markets in Group mode. The June spread group has been expanded and the mouse in this example is hovering over the June05-Dec05 spread. June 2005 is the current market, as is indicated by the fact it is highlighted. Alternatively, for example, if the reduced tick calendar spreads were enabled, two new groups would appear: one after the June spreads and the second after the September spreads. As shown in FIG. 5c, each portion of the user interface tab strip in accordance with the present invention includes a market selection region, which, in this case, includes the outright month tab (Jun05) and the calendar spread tab (Jun05-Dec05). Moreover, the calendar spread tab can be configured to include market group drop-down lists. As shown in FIG. 5d, user interface tab strips in accordance with the present invention can be configured to display the first two months of the outright and calendar markets in Group mode. Moreover, the spread group (in this case the September spread group) can be expanded by hovering the mouse pointer above the market group (in this case the Sep05-Sep06 spread). It is also contemplated that a expansion can occur by clicking on the mouse. In the example in FIG. 5d, June 2005 is the current market. Alternatively, for example, if the reduced tick calendar spreads were enabled, two new groups would appear: one after the June spreads and the second after the September spreads.

It is to be appreciated by those of ordinary skill that embodiments in accordance with the present invention can be achieved using a computer program. For example, the following code can be utilized in implementing certain embodiments in accordance with the teachings of the present invention:

```
SET oContract to a valid T4API Contract
SET oMarketList to oContract's list of available markets
FOR each individual oMarket that exist in the oMarketList
  IF oMarket should be ignored due to a filter THEN
    Skip this market and continue
  ELSE
    SET oTab as a new tab
    SET oTab's name and caption to oMarket specific values
    IF a previous tab has been displayed THEN
      Display oTab left docked to the previous tab
    ELSE
      Display oTab as the left most tab
    END IF
    IF the tabs don't all fit on the screen THEN
      Display left and right scroll buttons so that the end
      user an shift the tabs into view
    END IF
  END IF
END FOR
```

The invention has been described with reference to the preferred embodiments. Obviously, modifications and alterations will occur to others upon a reading and understanding of this specification. It is intended that the invention be construed as including all such modifications and alterations insofar as they come within the scope of the appended claims or the equivalents thereof.

What is claimed is:

1. An improved method for monitoring commodities over an exchange having contracts with multiple tradable markets, the method utilizing a software application and comprising the steps of:
providing a user interface tab strip including a plurality of individually selectable tabs, wherein each of the individually selectable tabs corresponds to a tradable market having a unique expiry date for each contract; and
allowing a user to switch between tradable markets by selecting a desired individually selectable tab corresponding to a desired tradable market.

2. The method of claim 1 wherein said user interface tab strip includes a first individually selectable tab displaying a first tradable market in a pre-determined list of tradable markets for said contract.

3. The method of claim 2 wherein said user interface tab strip includes a second individually selectable tab displaying a second tradable market in a pre-determined list of tradable markets.

4. The method of claim 1 wherein, upon user selection of each of the individually selectable tabs, corresponding market data for said tradable market is displayed.

5. The method of claim 4 wherein said corresponding market data is at least one of a bid price, an offer price, a trade price or combination of a bid price, an offer price, and a trade price.

6. The method of claim 4 wherein each of the individually selectable tabs within the plurality of individually selectable tabs becomes graphically accented upon selection.

7. The method of claim 1 wherein each of the individually selectable tabs may be selected by a user clicking on a desired tab.

8. The method of claim 1 wherein a user of said user interface tab strip may traverse from a first individually selectable tab to a second individually selectable tab by selecting a pre-determined key button on a keyboard; wherein said keyboard can be used in conjunction with said software application.

9. The method of claim 8 wherein said pre-determined button is a Tab button.

10. The method of claim 1 wherein each individually selectable tab within the user interface tab strip is horizontally adjacent to the previous individually selectable tab.

11. The method of claim 10 wherein said user interface tab strip includes a horizontal scroll bar to allow a user of said user interface tab strip to access any of the individually selectable tabs not visible to the user, wherein the user may select a portion of said horizontal scroll bar to effectuate movement of the visible screen.

12. The method of claim 10 wherein said user interface tab strip includes a horizontal scroll bar to allow a user of said user interface tab strip to access any of the individually selectable tabs not visible to the user, wherein the user may drag and drop said horizontal scroll bar to effectuate movement of the visible screen.

13. An improved method for monitoring commodities over an exchange having contracts with multiple tradable markets, the method utilizing a software application and comprising the steps of:
providing a user interface tab strip including a plurality of individually selectable tabs, wherein each of the individually selectable tabs corresponds to a tradable market having a unique expiry date for each contract;
applying a filter to the user interface tab strip so as to display a plurality of individually selectable tabs, wherein together all of the individual tabs represent a subset of tradable markets, for each contract,
allowing a user to select a tradable market from the subset of tradable markets by selecting an individually selectable tab corresponding to a desired tradable market.

14. The method of claim 13 wherein said user interface tab strip includes a first individually selectable tab displaying a first tradable market in a pre-determined list of tradable markets for said contract.

15. The method of claim 14 wherein said user interface tab strip includes a second individually selectable tab displaying a second tradable market in a pre-determined list of tradable markets for said contract.

16. The method of claim 13 wherein, upon user selection of each of the individually selectable tabs, corresponding market data for said tradable market is displayed.

17. The method of claim 16 wherein said corresponding market data is at least one of a bid price, an offer price, a trade price or combination of a bid price, an offer price, and a trade price.

18. The method of claim 13 wherein each of the individually selectable tabs within the plurality of individually selectable tabs becomes graphically accented upon user selection.

19. The method of claim 13 wherein each of the individually selectable tabs may be selected by a user clicking on a desired tab.

20. The method of claim 13 wherein a user of said user interface tab strip may traverse from a first individually selectable tab to a second individually selectable tab by selecting a pre-determined key button on a keyboard; wherein said keyboard can be used in conjunction with said software application.

21. The method of claim 20 wherein said pre-determined button is a Tab button.

22. The method of claim 13 wherein each individually selectable tab within the user interface tab strip is horizontally adjacent to the previous individually selectable tab.

23. The method of claim 22 wherein said user interface tab strip includes a horizontal scroll bar to allow a user of said user interface tab strip to access any of the individually selectable tabs not visible to the user.

24. The method of claim 13 wherein said filter can be applied to the superset of tradable markets for said contract so as to display the outright tradable markets for said contract.

25. The method of claim 13 wherein said filter can be applied to the superset of tradable markets for said contract so as to display tradable markets of a selectable strategy type.

26. The method of claim 25 wherein said selectable strategy type displays a plurality of individually selectable tabs that correspond to calendar spread tradable markets for said contract.

27. The method of claim 13 wherein said filter can be applied to the tradable markets for said contract so as to display exchange defined tradable markets for said contract.

28. The method of claim 13 wherein said filter can be applied to the tradable markets for said contract so as to display the first two months of tradable markets for said contract.

29. An improved method for monitoring commodities over an exchange having contracts with multiple tradable markets, the method utilizing a software application and comprising the steps of:
providing a user interface tab strip including a plurality of individually selectable tabs, wherein each of the individually selectable tabs includes a drop-down list of tradable markets having a unique expiry date and strategy type for each contract; and
allowing a user to select a tradable market by selecting an individual drop-down list item from the individually selectable tab corresponding to a tradable market.

30. The method of claim 29 wherein said drop-down list is displayed as a button when said drop-down list contains one tradable market.

31. The method of claim 29 wherein said user interface tab strip includes a first individually selectable tab displaying a first ordered subset of tradable markets for said contract.

32. The method of claim 31 wherein said user interface tab strip includes a second individually selectable tab displaying a second ordered subset of tradable markets for said contract, wherein the tradable markets of the second ordered subset are disjoint of the tradable markets of the first ordered subset.

33. The method of claim 32 wherein each individually selectable tab within the plurality of individually selectable tabs displays a subset of corresponding tradable markets upon selection of each of the individually selectable tabs; wherein the corresponding tradable markets of each of the individually selectable tabs subset is disjoint of the corresponding tradable markets of each other individually selectable tab subset within the plurality of individually selectable tabs.

34. The method of claim 33 wherein each subset represented by each of the individually selectable tab drop-down list is displayed in a predetermined order.

35. The method of claim 29 wherein, upon user selection of each of the individually selectable tabs, corresponding market data for said tradable market is displayed.

36. The method of claim 35 wherein said corresponding market data is at least one of a bid price, an offer price, a trade price or combination of a bid price, an offer price, and a trade price.

37. The method of claim 29 wherein, upon user selection of each individually selectable drop-down list item, corresponding market data for said tradable market is displayed.

38. The method of claim 37 wherein said corresponding market data is at least one of a bid price, an offer price, a trade price or combination of a bid price, an offer price, and a trade price.

39. The method of claim 29 wherein each of the individually selectable tabs within the plurality of individually selectable tabs becomes graphically accented upon user selection.

40. The method of claim 29 wherein each of the individually selectable tabs may be selected by a user clicking on a desired tab.

41. The method of claim 29 wherein each of the individually selectable tabs may be selected by a user clicking on an individual drop-down list item from the individually selectable tab.

42. The method of claim 29 wherein a user of said user interface tab strip may traverse from a first individually selectable tab to a second individually selectable tab by selecting a pre-determined key button on a keyboard; wherein said keyboard can be used in conjunction with said software application.

43. The method of claim 42 wherein said pre-determined button is a Tab button.

44. The method of claim 29 wherein said drop-down list of each of the individually selectable tabs can be expanded by actuating predetermined key strokes.

45. The method of claim 29 wherein said tab drop down list item within said drop down list may be selected by a user clicking to expand the list, followed by clicking on the desired item.

46. The method of claim 45 wherein each tradable market of the drop-down list may be selected by a user actuating a predetermined key stroke.

47. The method of claim 29 wherein each individually selectable tab within the user interface tab strip is horizontally adjacent to the previous individually selectable tab.

48. The method of claim 47 wherein said user interface tab strip includes a horizontal scroll bar to allow a user of said user interface tab strip to access any of the individually selectable tabs not visible to the user.

49. The method of claim 29 wherein each individually selectable tab within the plurality of individually selectable tabs represents a single tradable market.

50. The method of claim 49 wherein selecting a second individually selectable tab within the plurality of individually selectable tabs displays market data corresponding to said second individually selectable tab.

51. The method of claim 50 wherein selecting a tradable market within said drop-down list displays market data corresponding to the selected tradable market, switches to the item's corresponding tradable market and updates said tab's default market.

52. The method of claim 51 wherein selecting a tradable market within said drop-down list further switches to the corresponding tradable market.

53. The method of claim 51 wherein selecting a tradable market within said drop-down list further updates said tab's default market.

54. The method of claim 29 wherein the first tradable market displayed in the drop-down list is the default tradable market.

55. The method of claim 29 wherein the most recently selected tradable market in the drop-down list remains the default market.
